(19) United States
(12) Patent Application Publication
(10) Pub. No.: US 2017/0351669 A1
(43) Pub. Date: Dec. 7, 2017

(54) AUDIO/VIDEO SEARCHING METHOD, APPARATUS AND TERMINAL

(71) Applicants: HISENSE CO., LTD., QINGDAO (CN); HISENSE USA CORPORATION, SUWANEE, GA (US); HISENSE INTERNATIONAL CO., LTD., QINGDAO (CN)

(72) Inventors: LI YUAN, QINGDAO (CN); XINJUN GAN, QINGDAO (CN)

(21) Appl. No.: 15/394,742

(22) Filed: Dec. 29, 2016

(30) Foreign Application Priority Data
Jun. 2, 2016 (CN) 201610390175.7

(51) Int. Cl. G06F 17/30

(52) U.S. Cl. CPC G06F 17/30029; G06F 17/3005

(57) ABSTRACT

The disclosure provides an audio/video (A/V) searching method, an apparatus and a terminal, the method includes: receiving A/V querying statement; determine keyword from the A/V querying statement; obtaining at least one instance having association with the keyword; and constructing search result knowledge graph according to the keyword, instance and association between the keyword and the instance. The search result knowledge graph constructed according to embodiments of the disclosure presents, in the form of a diagram, the keyword of the A/V querying statement, the instance associated with the keyword, and the association between the keyword and the instance. The search result knowledge graph includes not only A/V search results corresponding to the A/V querying statement, but also the association between these results. Search results presented in this form are intuitive, concise, informative, and easy to use for the user, significantly enhancing user experience.

### CROSS-REFERENCE TO RELATED APPLICATIONS

This application claims priority to Chinese Patent Application No. 201610390175.7, filed on Jun. 2, 2016, entitled “AUDIO/VIDEO SEARCHING METHOD, APPARATUS AND TERMINAL”, which is hereby incorporated by reference in its entirety.

### TECHNICAL FIELD

This disclosure relates to the field of intelligent searching technologies and, particularly, to an audio/video searching method, an apparatus and a terminal.

### BACKGROUND

As various smart terminals are evolving, smart terminals are offering movie searching functions. For instance, when a smart terminal is a smart TV, the user may carry on man-machine interaction with the smart TV via a TV voice assistant provided thereon, or an audio/video entertainment robot connected thereto. The user can send a querying statement to the terminal, and then the terminal display the results found according to the querying statement.

In audio/video searching methods of prior art, by performing a predefined matching algorithm on keywords of the querying statement inputted by the user, A/V searching results corresponding to the keywords of the querying statement are obtained, and then presented in the form of a list to the user.

### SUMMARY

This disclosure provides an audio/video searching method, an apparatus and a terminal.

On one aspect, this disclosure provides an A/V searching method, including:

receiving an A/V querying statement;

determining a keyword from the A/V querying statement;

obtaining at least one instance having association with the keyword; and

constructing, a search result knowledge graph according to the keyword, the instance and the association between the keyword and the instance, where the search result knowledge graph is for presenting a search result corresponding to the A/V querying statement.

On another aspect, this disclosure provides an A/V searching apparatus, including:

a determining module, configured to determine a keyword from the A/V querying statement;

an obtaining module, configured to obtain at least one instance having association with the keyword; and

a constructing module, configured to construct a search result knowledge graph according to the keyword, the instance and the association between the keyword and the instance, where the search result knowledge graph is for presenting a search result corresponding to the A/V querying statement.

On yet another aspect, this disclosure provides an A/V searching apparatus, including: a memory storing instructions; a processor coupled with the memory and configured to execute the instructions stored in the memory, and the processor is configured to:

receive an A/V querying statement;

determine a keyword from the A/V querying statement;

obtain at least one instance having association with the keyword; and

construct a search result knowledge graph according to the keyword, the instance and the association between the keyword and the instance, where the search result knowledge graph is for presenting a search result corresponding to the A/V querying statement.

On still another aspect, this disclosure provides a terminal, where the terminal is provided with the above described A/V searching apparatus.

### BRIEF DESCRIPTION OF DRAWINGS

A brief introduction will be given hereinafter to the accompany drawings which will be used in the description of embodiments in order to explain the technical solutions of the embodiments of the present disclosure more clearly. Apparently, the drawings in the description below are merely illustrating some embodiments of the present disclosure. Those skilled in the art may obtain other drawings according to these drawings without paying any creative effort.

FIG. 1 is a flowchart illustrating an A/V searching method provided in some embodiments of this disclosure;

FIG. 2 is a first schematic diagram illustrating a search result knowledge graph in an A/V searching method provided in some embodiments of this disclosure;

FIG. 3 is a second schematic diagram illustrating a search result knowledge graph in an A/V searching method provided in some embodiments of this disclosure;

FIG. 4 is a flowchart illustrating an A/V searching method provided in some other embodiments of this disclosure;

FIG. 5 is a first schematic diagram illustrating a search result knowledge graph in an A/V searching method provided in some other embodiments of this disclosure;

FIG. 6 is a second schematic diagram illustrating a search result knowledge graph in an A/V searching method provided in some other embodiments of this disclosure;

FIG. 7 is a third schematic diagram illustrating a search result knowledge graph in an A/V searching method provided in some other embodiments of this disclosure;

FIG. 8 is a flowchart illustrating an A/V searching method provided in yet some other embodiments of this disclosure;

FIG. 9 is a schematic structural diagram illustrating an A/V searching apparatus provided in some embodiments of this disclosure; and

FIG. 10 is a schematic structural diagram illustrating an A/V searching apparatus provided in some other embodiments of this disclosure.

### DETAILED DESCRIPTION

In order to make objectives, technical solutions and advantages of embodiments of the present disclosure clearer, the technical solutions in the embodiments of the present disclosure will be described hereunder clearly and comprehensively with reference to accompanying drawings. Obviously, the described embodiments are only a part of embodiments of the present disclosure, rather than all of them. All other embodiments obtained by those of ordinary skill in the art based on the embodiments of the present disclosure herein without any creative effort shall fall into the protection scope of the present disclosure.

Now, the application scenarios of embodiments of this disclosure will be introduced before the embodiments are described in detail. The method provided in embodiments of this disclosure is applied to a terminal which is configured with at least an A/V searching functionality that enables searching for audio/videos on the terminal. For instance, the terminal may be a smartphone, a smart TV, a high definition (HD) set-top box, a tablet, a laptop, an ultra-mobile personal computer (UMPC), a netbook, or a personal digital assistant (PDA) or the like. Meanwhile, the A/V searching functionality provided in the terminal may be realized through application softwares that are installed in the terminal and have A/V searching functionalities, such as QQLive, iQIYI, Baidu, etc.

The method provided in this disclosure is adapted to various types of operating systems, e.g. Windows, Android, etc. As an example, the method provided in embodiments of this disclosure may be applied to tablets, laptops, UMPCs and netbooks and other terminals having Windows system, and may also be applied to smartphones and smart TVs and other terminals having Android system.

The apparatus and terminal provided in this disclosure can employ any of the existing operating systems, such as Windows or Android system or the like, which will not be limited in embodiments of this disclosure.

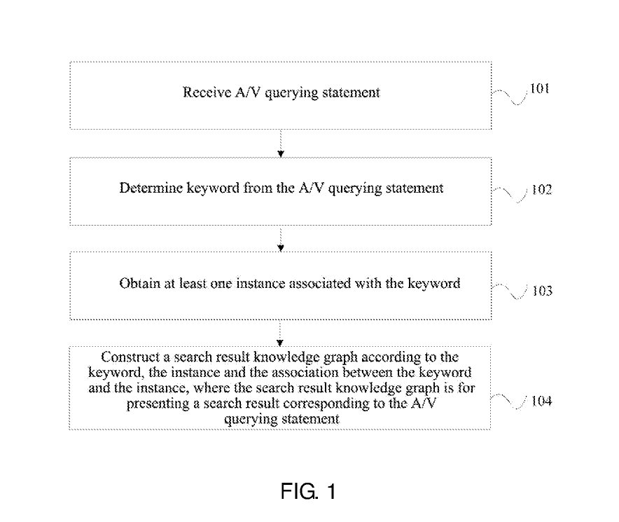

FIG. 1 is a flowchart illustrating an A/V searching method provided in some embodiments of this disclosure. As depicted in FIG. 1, the method of these embodiments include:

Step 101: receive an A/V querying statement.

A user may send an A/V querying statement to a terminal to query for an audio/video (A/V). For example, the user may input texts or voices via a remote control or other control devices, so that the remote control or other control devices can send the texts or voices inputted by the user to the terminal, allowing the terminal to receive the A/V querying statement. For another example, the user may directly input a voice message on the terminal, where the voice message is an A/V querying statement, allowing the terminal to receive the A/V querying statement.

For instance, the user may input voice information Search for the movie Infernal Affairs on a speech inputting apparatus provided on the terminal. After receiving the voice information, the terminal performs speech recognition on the voice information, thus obtaining the A/V querying statement Search for the movie Infernal Affairs inputted by the user.

Step 102: determine a keyword from the A/V querying statement.

In this embodiment, the terminal may perform intelligent recognition on the A/V querying statement to obtain the keyword contained in the A/V querying statement.

For example, if an A/V querying statement Infernal Affairs is received from the user or other control devices, the terminal can perform word segmentation, natural language recognition and the like on the A/V querying statement to identify that the querying statement contains the keyword Infernal Affairs. If an A/V querying statement Infernal Affairs starring Andy Lau is received from the user or other control devices, the terminal can perform word segmentation on the A/V querying statement to identify that the querying statement contains the keywords Andy Lau and Infernal Affairs.

Step 103: obtain at least one instance having association with the keyword.

According to a possible implementation, the terminal in this embodiment has an A/V knowledge graph constructed through information crawling and structuring. Or, a server has an A/V knowledge graph constructed through information crawling and structuring, and the terminal may acquire the A/V knowledge graph in the server either in wired mode or in wireless mode. After the keyword in the A/V querying statement is determined, the terminal can obtain at least one instance having association with the keyword in the A/V knowledge graph based on the location of the keyword in the A/V knowledge graph.

According to another possible implementation, after the keyword in the A/V querying statement is determined, the terminal can obtain at least one instance having association with the keyword through web information crawling and natural language analysis, which will not be limited herein.

For example, after determining the keyword movie in the A/V querying statement I'd watch some movie and thus obtaining from the A/V knowledge graph instances associated with the keyword movie such as Zootopia, Black Butler, Detective Chinatown, My Beloved Bodyguard, Yesterday Once More, Shooter, Captain America 3, Jurassic World, Warrior and A Perfect World and the like, the terminal may determine five of the instances which have association with movie and have higher number of views, e.g. Zootopia, Detective Chinatown, Captain America 3, Jurassic World, and Yesterday Once More.

For another example, after determining the keyword Yang Mi in the A/V querying statement Search for Yang Mi and thus obtaining, by web information crawling, instances associated with the keyword Yang Mi such as Swords of Legends, Les Interprètes, Chinese Paladin 3, My Sunshine, The Witness, The Palace, The Return of the Condor Heroes, Tiny Times, The Breakup Guru, Painted Skin 2, Legend of the Military Seal, Hawick Hau-Wai Lau and Liu Yan and the like, the terminal may determine five of the instances which have association with Yang Mi and have higher number of clicks, e.g. Swords of Legends, Les Interprètes, Tiny Times, The Breakup Guru and Painted Skin 2.

Step 104: construct a search result knowledge graph according to the keyword, the instance and the association between the keyword and the instance, where the search result knowledge graph is for presenting a search result corresponding to the A/V querying statement.

In this embodiment, when the terminal determines at least one instance associated with the keyword in the A/V querying statement, the association between the keyword and the instance may include any one of the following cases. If the keyword is a subject keyword, the association between the keyword and the instance is that the instance belongs to the keyword. For example, an instance Hu Ge belongs to the keyword Actor, and an instance Kung Fu Jungle belongs to the keyword Movie. If the keyword is an instance keyword, the association between the instance and the keyword may be that: the instance and the keyword belong to the same subject keyword; the instance and the keyword are starring the same actor/actress; the instance and the keyword are sharing the same director; the instance is starring the keyword (i.e. name of an actor/actress); the instance is directed by the keyword (i.e. name of a director). For example, the instance Chinese Paladin stars the keyword Hu Ge, the keyword The Myth shares the same actor Hu Ge with the instance The Disguiser. Then, a search result knowledge graph corresponding to the A/V querying statement can be constructed according to the found information, i.e. the instances, keywords and the association between the keywords and the instances and the like. Such a search result knowledge graph is a diagram that is constructed by the keywords, the at least one instance having association with the keywords and the association between the keywords, and has connections and connecting lines.

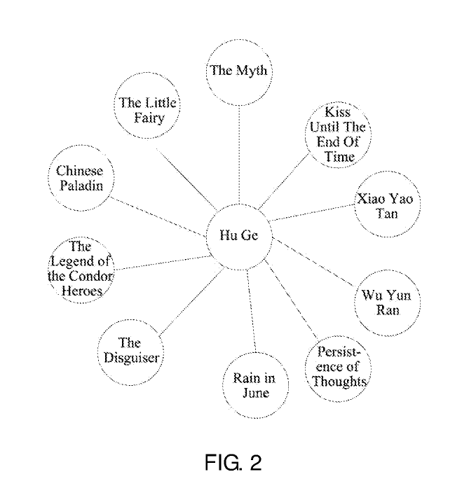

For example, after identifying the keyword Hu Ge in the A/V querying statement Search for Hu Ge, the instances such as Chinese Paladin, The Little Fairy, The Myth, The Legend of The Condor Heroes, The Disguiser and the like, as well as the instances such as The Persistence of Thoughts, Rain in June, Wu Yun Ran, Xiao Yao Tan and Kiss Until The End Of Time and the like, which have association with the keyword Hu Ge, may be determined. After sorting these determined instances, a search result knowledge graph as depicted in FIG. 2 may be determined according to the keyword Hu Ge and a plurality of instances ranked in the front. FIG. 2 depicts the search result knowledge graph which corresponds to the A/V querying statement Search for Hu Ge containing the keyword Hu Ge and is constructed according to the A/V searching method provided in the embodiment of this disclosure.

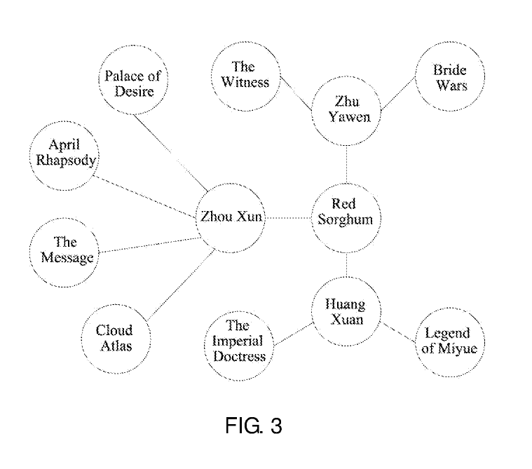

For another example, after identifying that the A/V querying statement Search for Red Sorghum starring Zhou Xun has the keywords Zhou Xun and Red Sorghum, the terminal may determine, based on Zhou Xun and the A/V knowledge graph, all instances having association with the keyword Zhou Xun, and sort all these instances having association with the keyword Zhou Xun to determine top ranked instances, e.g. Red Sorghum, Palace of Desire, April Rhapsody, The Message, and Cloud Atlas. Meanwhile, the terminal may also determine, based on Red Sorghum and the A/V knowledge graph, all instances having association with Red Sorghum, e.g. Huang Xuan, Zhu Yawen (both are actors in Red Sorghum), and determine top ranked instances associated with the instance Huang Xuan, e.g. Legend of Miyue, The Imperial Doctress, as well as top ranked instances associated with the instance Zhu Yawen, e.g. The Witness, Bride Wars, thereby determining the search result knowledge graph as depicted in FIG. 3. FIG. 3 depicts the search result knowledge graph which corresponds to the A/V querying statement Search for Red Sorghum starring Zhou Xun containing the keywords Zhou Xun and Red Sorghum and is constructed according to the A/V searching method provided in the embodiment of this disclosure.

This embodiment determines the keyword in the received A/V querying statement; obtains at least one instance having association with the keyword; then constructs the search result knowledge graph according to the keyword, the instance and the association between the keyword and the instance; where the constructed search result knowledge graph presents the keyword in the A/V querying statement, the instance associated with the keyword, and the association between the keyword and the instance in the form of a diagram. Accordingly, the search result knowledge graph includes not only A/V search results corresponding to the A/V querying statement, but also the association between these results. Search results presented in this form are intuitive, concise, informative, and easy to use for the user, significantly enhancing the user experience.

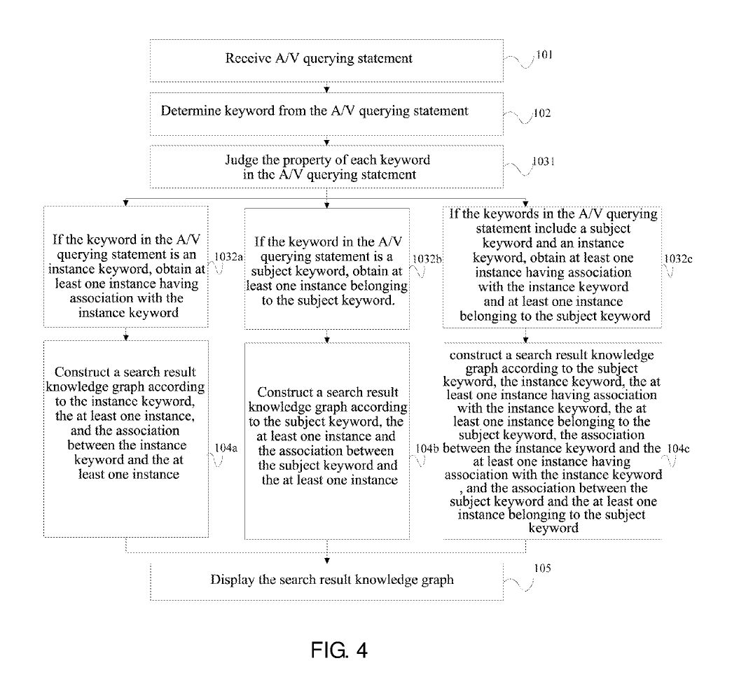

FIG. 4 is a flowchart illustrating an A/V searching method provided in some other embodiments of this disclosure. On the basis of the above described embodiments, the execution of the step 103 begins from determining whether the keyword in the A/V querying statement is a subject keyword or an instance keyword, then proceeds to obtaining at least one instance having association with the instance keyword and/or at least one instance belonging to the subject keyword according to the keyword in the A/V querying statement. As depicted in FIG. 4, the aforementioned step 103 and step 104 are carried out as follows.

Step 1031: judge the property of each keyword in the A/V querying statement.

In this embodiment, the terminal can determine the property of each keyword in the A/V querying statement, where the property of a keyword may be categorized into subject and instance, so that the terminal can determine whether each keyword in the A/V querying statement is a subject keyword or an instance keyword.

For example, the terminal may determine the property of each keyword in the A/V querying statement according to the A/V knowledge graph. For instance, the terminal stores an A/V knowledge graph constructed through information crawling and structuring. Or, a server stores an A/V knowledge graph constructed through information crawling and structuring, and the terminal may acquire the A/V knowledge graph in the server either in wired mode or in wireless mode. A plurality of subject keywords are set in the A/V knowledge graph, and each subject keyword has a plurality of instances belonging to the subject keyword and the association between these instances.

The subject keywords in embodiments of this disclosure may be names of genres in the field of A/V entertainment. For example, a subject keyword may be a noun, e.g. actor, singer, song title, movie, TV drama, variety show, etc.

An instance keyword refers to an instance under a subject keyword. That is, an instance is a particular name or title of works or the like which is covered under a subject keyword. For example, being the name of an actor, Andy Lau is an instance under the subject keyword Actor. Similarly, being the name of a movie, Infernal Affairs is an instance under the subject keyword Movie.

As an example, after obtaining the keywords Andy Lau and Movie in an A/V querying statement Search for a movie starring Andy Lau, the terminal can proceed to determine that the keyword Movie is a subject keyword, and the keyword Andy Lau is an instance keyword. Again, after obtaining the keywords Movie and Kung Fu Jungle in an A/V querying statement Search for the movie Kung Fu Jungle, the terminal can proceed to determine that the keyword Movie is a subject keyword and the keyword Kung Fu Jungle is an instance keyword covered under the subject keyword Movie. Similarly, after obtaining the keyword Kevin Tsai from an A/V querying statement Search for Kevin Tsai, the terminal can proceed to determine that the keyword Kevin Tsai is an instance keyword.

The terminal can determine the number of keywords in the A/V querying statement and the property of each keyword, and then determine which keywords in the A/V querying statement are subject keywords, and which are instance keywords. Further, the terminal may determine that all the keywords in the A/V querying statement are instance keywords, or that all the keywords in the A/V querying statement are subject keywords, or that some of the keywords in the A/V querying statement are instance keywords and some are subject keywords.

On one aspect, if the keyword in the A/V querying statement is an instance keyword, step 1032a and step 104a are executed.

Step 1032a: if the keyword in the A/V querying statement is an instance keyword, obtain at least one instance having association with the instance keyword.

Step 104a: construct a search result knowledge graph according to the instance keyword, the at least one instance, and the association between the instance keyword and the at least one instance.

After analyzing the A/V querying statement, if the terminal determines that the keywords in the A/V querying statement are instance keywords, it can be determined that all the keywords in the A/V querying statement are instance keywords and none is a subject keyword. For example, the terminal can determine, based on the A/V knowledge graph, that both keywords Hu Ge and Nirvana in Fire in the A/V querying statement Search for Nirvana in Fire starring Hu Ge are instance keywords.

After determining that all the keywords in the A/V querying statement are instance keywords, the terminal can determine at least one instance associated with the instance keyword according to the position relation of the instance keyword in the A/V knowledge graph. For example, the terminal may select, among the instances associated with the instance keyword, a first predefined number of instances having predefined popularity or similarity, such as five instances having popularity that is larger than a predefined value.

For example, if the instance keyword in the A/V querying statement is Tony Leung, the instances found to be associated with the instance Tony Leung may be Infernal Affairs, The Grandmaster, The Great Magician, The Silent War, Red Cliff and Confession of Pain and the like, which are movies associated with Tony Leung because Tony Leung is an actor of these movies. Then, these instances associated with the instance Tony Leung may be sorted according to their popularity, thus determining the first predefined number of instances with relatively high popularity among the viewers. Or, similarity of these instances associated with the instance Tony Leung may be determined, thus determining the first predefined number of instances with higher similarities. The first predefined number may be three, thus three instances, e.g. Infernal Affairs, The Grandmaster and The Silent War, associated with the instance keyword Tony Leung may be determined.

Then, the terminal can generate the search result knowledge graph according to the instance keyword, the first predefined number of instances, and the association between the instance keyword and the first predefined number of instances.

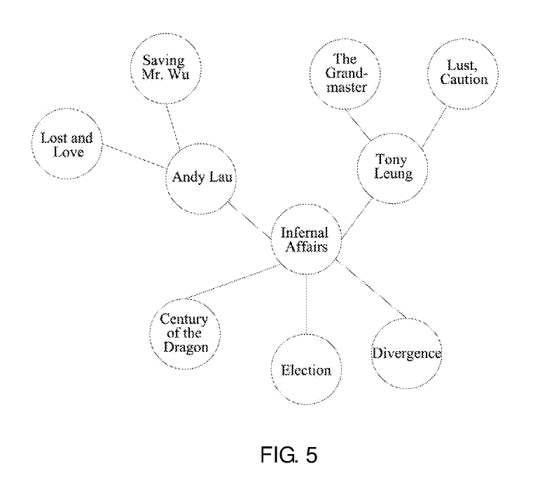

For example, the user may send a voice I'd watch Andy Lau and Tony Leung's Infernal Affairs to the terminal. The terminal determines that the instance keywords in the A/V querying statement I'd watch Andy Lau and Tony Leung's Infernal Affairs are Andy Lau, Tony Leung and Infernal Affairs. The terminal may determine that Andy Lau and Tony Leung among the three instance keywords are associated with Infernal Affairs, respectively, hence there are connections between Andy Lau, Tony Leung and Infernal Affairs. Then, the terminal first constructs a preliminary search result knowledge graph according to the connections between Andy Lau, Tony Leung and Infernal Affairs. After that, the terminal determines, according to the determined instance keyword Andy Lau, the first predefined number of instances associated with Andy Lau, e.g. Saving Mr. Wu and Lost and Love, both of which are instances having relatively high popularity or similarity. The terminal also determines the first predefined number of instances associated with Tony Leung, e.g. The Grandmaster and Lust, Caution, both of which are instances having relatively high popularity or similarity. In both cases, the first predefined number is two. The terminal can determine that the first predefined number of movies having association with Infernal Affairs, such as Election, Century of the Dragon and Divergence, which belong to the same genre, are instances having relatively high popularity or similarity, where the first predefined number is three. It may also be predefined that no more than 10 instances associated to each instance keyword may be determined. After these, a search result knowledge graph as depicted in FIG. 5 may be determined according to the above determined instances and the association between each instance keyword and each instance. FIG. 5 depicts the search result knowledge graph, which corresponds to the A/V querying statement I'd watch Andy Lau and Tony Leung's Infernal Affairs containing the keywords Andy Lau, Tony Leung and Infernal Affairs and is constructed according to the A/V searching method provided in the embodiment of this disclosure.

On another aspect, if the keyword in the A/V querying statement is a subject keyword, step 1032b and step 104b are executed.

Step 1032b: if the keyword in the A/V querying statement is a subject keyword, obtain at least one instance belonging to the subject keyword.

Step 104b: construct a search result knowledge graph according to the subject keyword, the at least one instance and the association between the subject keyword and the at least one instance.

After analyzing the A/V querying statement, if the terminal determines that the keywords in the A/V querying statement are subject keywords, it can be determined that all the keywords in the A/V querying statement are subject keywords and none is an instance keyword. For example, the terminal can determine, based on the A/V knowledge graph, that both keywords movie and music in the A/V querying statement Search for some movie and music are subject keywords.

The terminal can determines the instances belonging to respective subject keywords in the A/V querying statement, and then select at least one instance belonging to the subject keyword. For example, a second predefined number of instances belonging to the subject keyword may be determined according to the popularity, similarity of respective instances and the like. Since an instance belongs to a subject keyword, the association between the subject keyword and the instance can be determined. After that, a search result knowledge graph may be generated according to the subject keywords, the second predefined number of instances covered under the subject keywords, and the association between the subject keywords and the instances. Then, the search result knowledge graph may be presented, allowing the user to intuitively select and view the instances in the search result knowledge graph.

For example, if the subject keyword in the A/V querying statement is Movie, instances having association with Movie, e.g. Cherish Our Love Forever, The Crossing, My Lucky Star and The Greatest Love and the like may be determined, and these instances belong to the subject keyword Movie. Meanwhile, these instances under the instance keyword Movie may be ranked according to their popularity, so that the second predefined number of instances with relatively high popularity rankings can be determined. Or, the similarity of respective instances associated to the subject keyword Movie can be determined, so that the second predefined number of instances with relatively high similarity can be determined. The second predefined number may be three, so that three instances having association with the subject keyword Movie, e.g. Cherish Our Love Forever, The Crossing and The Greatest Love, can be determined.

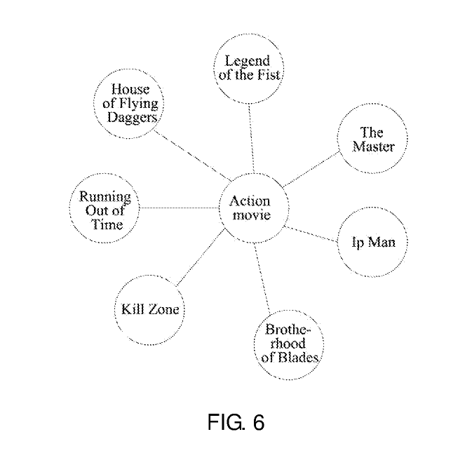

As an example, the user sends a voice I'd like some action movie to the terminal. The terminal determines that this A/V querying statement has subject keywords Movie and Action, and that the Action is a sub-branch under the subject keyword Movie. Thus, the terminal may locate the subject keyword Movie in the A/V knowledge graph, then query about the position of Action under the subject keyword Movie and instances belonging to the keyword Action. The terminal can select the second predefined number of instances having predefined popularity or predefined similarity according to the popularity or similarity of respective instances, where the second predefined number of instances are associated with the subject keyword Movie. After that, a search result knowledge graph can be constructed according to the subject keyword, the second predefined number of instances and the association between the subject keyword and the second predefined number of instances. The terminal may determine a search result knowledge graph as depicted in FIG. 6 by selecting no more than 10 instances, e.g. House of Flying Daggers, Running Out of Time, Kill Zone, Brotherhood of Blades, Ip Man, The Master and Legend of the Fist, all of which have relatively high popularity or similarity. FIG. 6 depicts the search result knowledge graph which corresponds to the A/V querying statement I'd like some action movie containing the keywords Movie and Action and is constructed according to the A/V searching method provided in the embodiment of this disclosure.

On yet another aspect, if the keywords in the A/V querying statement include a subject keyword and an instance keyword, step 1032c and step 104c are executed.

Step 1032c: if the keywords in the A/V querying statement include the subject keyword and the instance keyword, obtain at least one instance having association with the instance keyword and at least one instance belonging to the subject keyword.

Step 104c: construct a search result knowledge graph according to the subject keyword, the instance keyword, the at least one instance having association with the instance keyword, the at least one instance belonging to the subject keyword, the association between the instance keyword and the at least one instance having association with the instance keyword, and the association between the subject keyword and the at least one instance belonging to the subject keyword.

After analyzing the A/V querying statement, if the terminal determines that the keywords in the A/V querying statement include at least one instance keyword and at least one subject keyword, it can be determined that the keywords in the A/V querying statement include both the instance keyword and the subject keyword. For example, the terminal can determine, based on the A/V knowledge graph, that keywords Andy Lau and Infernal Affairs in the A/V querying statement Search for the movie Infernal Affairs starring Andy Lau are instance keywords, while movie is a subject keyword.

The terminal can obtain at least one instance having association with the instance keyword according to the A/V knowledge graph, for example, a first predefined number of instances associated with the instance keyword can be obtained; and the terminal can obtain at least one instance belonging to the subject keyword, for example, a second predefined number of instances belonging to the subject keyword can be obtained. At this time, the first predefined number of instances have certain association with the instance keyword because the first predefined number of instances are obtained according to the instance keyword, and the second predefined number of instances have certain association with the subject keyword because the second predefined number of instances are instances under the subject keyword. Moreover, the first predefined number of instances will have certain association with the second predefined number of instances because the instance keyword and the subject keyword may have a certain connection when both are included in the same A/V querying statement.

For example, an A/V querying statement includes keywords Tony Leung, Zhang Ziyi and Movie, the first predefined number of instances having association with the instance keyword Tony Leung, e.g. Infernal Affairs and The Grandmaster can be determined; the first predefined number of instances having association with the instance keyword Zhang Ziyi, e.g. The Crossing and The Grandmaster can be determined; and the second predefined number of instances having association with the subject keyword Movie, e.g. Cherish Our Love Forever, The Crossing and The Greatest Love can be determined. Then, it can be determined that the subject keyword Movie has association with the instance keywords Tony Leung and Zhang Ziyi because the instance keywords Tony Leung and Zhang Ziyi took acting part in movies. Since the instance keyword Tony Leung took a role in the Infernal Affairs and The Grandmaster, the first predefined number of instances Infernal Affairs and The Grandmaster have association with the instance keyword Tony Leung. Similarly, the instance keyword Zhang Ziyi took a role in the The Crossing and The Grandmaster, hence the first predefined number of instances The Crossing and The Grandmaster have association with the instance keyword Zhang Ziyi. Since both instance keywords Zhang Ziyi and Tony Leung took a role in The Grandmaster, the association between the instance keywords Zhang Ziyi and Tony Leung is that both are associated with The Grandmaster.

Further, the terminal may filter these subject keywords to determine filtered subject keywords. The terminal may analyze respective subject keywords to determine which subject keywords are subject keywords to which the respective instance keywords belong. Then the terminal can ignore the subject keyword to which the instance keywords belong, thus determining the filtered subject keywords.

For example, after determining that Actor, Director and Movie are the subject keywords while Andy Lau and Andrew Lau are the instance keywords, the terminal can determine, after analyzing, that the instance keyword Andy Lau is an instance under the subject keyword Actor and the instance keyword Andrew Lau is an instance under the subject keyword Director. The terminal can ignore the subject keywords Actor and Director while selecting the subject keyword Movie.

Then the terminal determines instances under the filtered subject keywords. The terminal can determine instances that the respective filtered subject keywords have in the A/V knowledge graph.

For example, the terminal has determined the filtered subject keyword to be Movie, and the terminal can determine that the subject keyword Movie has instances such as Infernal Affairs, The Message, The Breakup Guru, Daisy, Look For A Star, The Guillotines, The Mermaid and Monk Comes Down the Mountain, etc.

Then, the terminal determines whether the instances under the filtered subject keywords have association with the instance keywords. The terminal searches in the instances under the filtered subject keywords to determine whether the instances under the filtered subject keywords have association with the instance keywords.

For example, after determining that the instances Infernal Affairs, The Message, The Breakup Guru, Daisy, Look For A Star, The Guillotines, The Mermaid and Monk Comes Down the Mountain etc. belong to the subject keyword Movie, the terminal can determine whether these instances have association with the instances Andy Lau and Andrew Lau.

If the terminal determines that the instances under the filtered subject keywords have association with the instance keywords, the terminal can determine the instances that are associated with the instance keywords and belong to the filtered subject keywords. The terminal can determine the first predefined number of instances having association with the instance keywords, and the second predefined number of instances belonging to the filtered subject keywords. Since the association between the keywords, the association between the instances, and the association between the instances and the keywords can be determined during the above described process, a search result knowledge graph can be generated according to the subject keywords, the instance keywords, the first predefined number of instances, the second predefined number of instances, the association between the instance keywords and the first predefined number of instances, the association between the subject keywords and the second predefined number of instances, and the association between the keywords.

The terminal determines that the instances under the subject keyword include an instance associated with the instance keyword, thus the terminal can determine that this instance is associated with the instance keyword and belongs to the subject keyword.

Then, the terminal can determine instances having association with the instance keywords, pick out the first predefined number of instances among the instances having association with the instance keywords, where the first predefined number may be determined according to the popularity or similarity of the instances. For example, five instances with popularity ratings of above a predefined value, or three instances having relatively high similarity. Meanwhile, the terminal can locate each filtered subject keyword in the A/V knowledge graph constructed according to information. Then, the terminal can determine the instances under each filtered subject keyword, so as to pick out the second predefined number of instances, where the second predefined number may be determined according to the popularity or similarity of the instances. For example, five instances with popularity ratings of above a predefined value, or five instances having relatively high similarity. Then, the terminal can generate a search result knowledge graph based on the instances that are associated with the instance keywords and belong to the filtered subject keywords, the first predefined number of instances having association with the instance keywords, the second predefined number of instances belonging to the filtered subject keywords, as well as the association between the instance keywords and the first predefined number of instances, the association between the subject keywords and the second predefined number of instances, and the association between the keywords. The search result knowledge graph can be presented for the user to view and select instances in the search result knowledge graph.

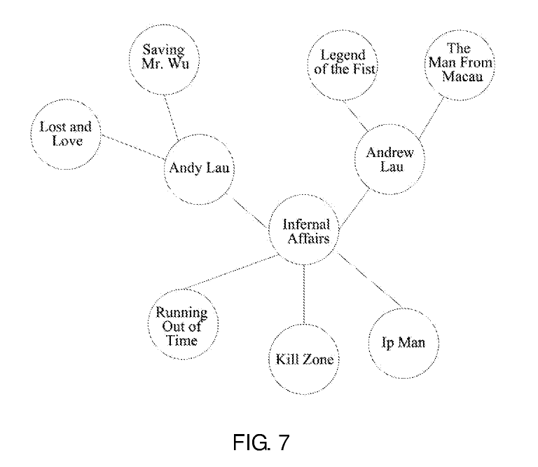

As an example, the user may send a voice I'd watch some movie involving actor Andy Lau and director Andrew Lau to the terminal. The terminal determines that the A/V querying statement I'd watch some movie involving actor Andy Lau and director Andrew Lau has instance keywords Andy Lau and Andrew Lau, as well as subject keywords actor, director and movie. After filtering, the terminal ignores the subject keywords actor and director, and selects the subject keyword movie. Then, the terminal determines that movie contains instances such as Infernal Affairs, The Message, The Breakup Guru, Daisy, Look For A Star, The Guillotines, The Mermaid and Monk Comes Down the Mountain etc. After that, the terminal determines that the instance Infernal Affairs in the instances under movie is associated with the instance keywords Andy Lau and Andrew Lau. The terminal may also determine the first predefined number of instances associated with Andy Lau, e.g. Saving Mr. Wu and Lost and Love, as well as the first predefined number of instances associated with Andrew Lau, e.g. Legend of the first and The Man From Macau, where the Saving Mr. Wu, Lost and Love, Legend of the first and The Man From Macau are all instances having relatively high popularity and similarity. The terminal can further determine the Infernal Affairs as an action movie under the movie, and hence determine the second predefined number of instances under the action movie, e.g. Running Out of Time, Kill Zone and Ip Man, all of which are instances having relatively high popularity and similarity. Thus, the terminal can select no more than 10 instances with relatively high popularity, and determines a search result knowledge graph as depicted in FIG. 7. FIG. 7 depicts the search result knowledge graph which corresponds to the A/V querying statement I'd watch some movie involving actor Andy Lau and director Andrew Lau containing instance keywords Andy Lau and Andrew Lau, subject keywords actor, director and movie, and is constructed according to the A/V searching method provided in the embodiment of this disclosure.

Finally, the terminal presents, at step 105, the search result knowledge graph constructed after the aforementioned steps.

In this embodiment, the constructed search result knowledge graph is presented by the terminal in a diagram form, which is more intuitive. The terminal presents the search result knowledge graph in a graphic form to present the search result for the A/V, after determining the search result knowledge graph corresponding to the keywords according to the keywords in the querying statement.

When determining that the keywords in the A/V querying statement include subject keywords and instance keywords, this embodiment begins filtering the subject keywords to determine filtered subject keywords, and proceeds to determining instances having association with the instance keywords among the instances under each of the filtered subject keywords. After this, the search result knowledge graph can be constructed according to the subject keywords, the instance keywords, the first predefined number of instances having association with the instance keywords, the second predefined number of instances belonging to the filtered subject keywords, the association between the instance keywords and the first predefined number of instances, the association between the subject keywords and the second predefined number of instances, and the association between the keywords. The search result knowledge graph thus constructed presents, in the form of a diagram, the keywords in the A/V querying statement, the instances associated with the keywords, and the association between the keywords and the instances. Accordingly, the search result knowledge graph includes not only A/V search results corresponding to the A/V querying statement, but also the association between these results. Search results presented in this form are intuitive, concise, informative, and easy to use for the user, significantly enhancing the user experience. Meanwhile, since the search result knowledge graph can present the association between the keywords in the A/V querying statement, the association between the keywords and the instances, and the association between the instances, the search result knowledge graph can include not only the search results most relevant to the user's query, but also the association between the results, as well as instances having certain association with the most relevant results, allowing the user to refer to the search result knowledge graph thus displayed and determine which of the instances fully or partially match the user's querying statement. This can help the user interpret the results, preventing misunderstanding of the search results thus presented.

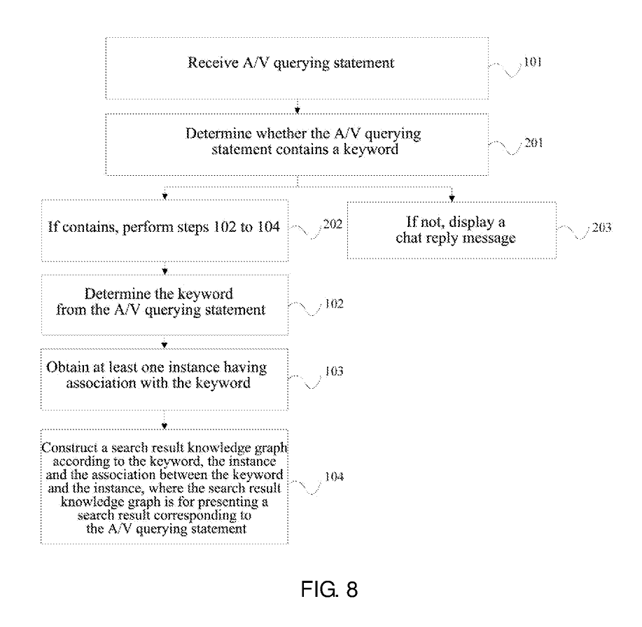

FIG. 8 is a flowchart illustrating an A/V searching method provided in yet some other embodiments of this disclosure. On the basis of the foregoing embodiments, as depicted in FIG. 8, the step 101 of the method in this embodiment includes:

receiving speech querying information for A/V; and obtaining the A/V querying statement by performing speech recognition on the speech querying information.

In this embodiment, the user is allowed to input a voice to a control device, so that the control device can receive speech querying information for A/V and send the same to a terminal. Or, the user inputs the voice straightly to the terminal, and the terminal directly acquires the speech querying information from the user input. The terminal performs speech recognition on the acquired speech querying information to convert the same into text, thus generating an A/V querying statement.

As an example, the terminal receives speech querying information I'd watch Andy Lau's movie, and converts the same into text “I'd watch Andy Lau's movie”, thus obtaining the A/V querying statement I'd watch Andy Lau's movie.

After step 101, the method further includes:

Step 201: determine whether the A/V querying statement contains a keyword.

In this embodiment, the terminal receives, processes and analyzes the speech querying information to obtain the A/V querying statement. Then, the terminal analyzes the A/V querying statement to determine whether the A/V querying statement contains any keyword. It is needed to determine whether the A/V querying statement contains at least one keyword.

For example, if Andy Lau, Movie are found in the A/V querying statement determined by the terminal, keywords Andy Lau and Movie can be determined.

For another example, if the A/V querying statement determined by the terminal reads What's your name, it is determined that no keyword is included in the A/V querying statement.

Step 202: if contains, perform step 102 to step 104.

In this embodiment, if determining that the A/V querying statement contains the keyword, the terminal can perform step 102 to step 104 to present the search result knowledge graph.

Step 203: if not, display a chat reply message.

In this embodiment, if determining that no keyword is included in the A/V querying statement, no keyword can be located in the A/V knowledge graph, nor can any instance be determined, etc. In this case, the terminal can switch to a chatting module to display a chat reply message.

For example, if the A/V querying statement determined by the terminal reads What's your name, it is determined that no keyword is included in the A/V querying statement, thus determining that the A/V querying statement does not have a keyword. Now the terminal can switch into a chatting mode. As an example, the terminal may reply I'm a voice robot in response to the statement What's your name.

This embodiment can determine the A/V querying statement by performing recognition on the speech querying information, and analyze the A/V querying statement to determine whether the A/V querying statement contains any keyword. When determining that the A/V querying statement contains the keyword, the search result knowledge graph can be constructed. The search result knowledge graph thus constructed presents, in the form of a diagram, the keywords in the A/V querying statement, the instances associated with the keywords, and the association between the keywords and the instances. Accordingly, the search result knowledge graph includes not only A/V search results corresponding to the A/V querying statement, but also the association between these results. Search results presented in this form are intuitive, concise, informative, and easy to use for the user, significantly enhancing the user experience. If determining that no keyword is contained in the A/V querying statement, the terminal can switch to voice chatting.

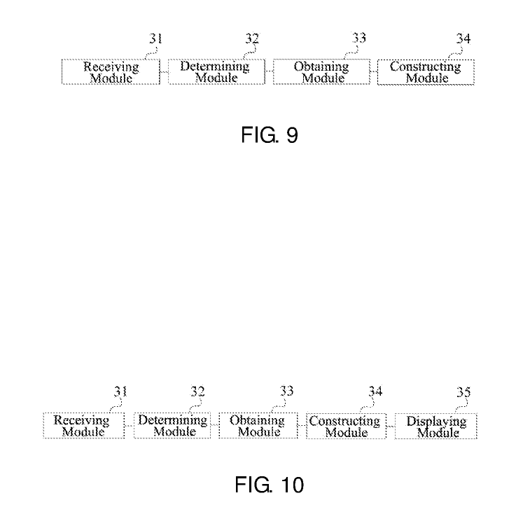

FIG. 9 is a schematic structural diagram illustrating an A/V searching apparatus provided in some embodiments of this disclosure. As depicted in FIG. 9, the A/V searching apparatus provided in this embodiment includes:

a receiving module 31, configured to receive an A/V querying statement;

a determining module 32, configured to determine a keyword from the A/V querying statement;

an obtaining module 33, configured to obtain at least one instance having association with the keyword; and

a constructing module 34, configured to construct a search result knowledge graph according to the keyword, the instance and the association between the keyword and the instance, where the search result knowledge graph is for presenting a search result corresponding to the A/V querying statement.

The A/V searching apparatus of this embodiment is capable of executing the A/V searching method provided in embodiments of this disclosure following similar principals, which will not be repeated herein.

In this embodiment, by determining the keyword in the received A/V querying statement, obtaining at least one instance having association with the keyword, the search result knowledge graph can be constructed according to the keyword, the instance and the association between the keyword and the instance; and the constructed search result knowledge graph presents the keywords in the A/V querying statement, the instances associated with the keywords, and the association between the keywords and the instances in the form of a diagram. Accordingly, the search result knowledge graph includes not only A/V search results corresponding to the A/V querying statement, but also the association between these results. Search results presented in this form are intuitive, concise, informative, and easy to use for the user, significantly enhancing the user experience.

FIG. 10 is a schematic structural diagram illustrating an A/V searching apparatus provided in some other embodiments of this disclosure. On the basis of the foregoing embodiments, as depicted in FIG. 10, the obtaining module 33 included in the A/V searching apparatus provided in this embodiment is configured to:

determine whether the keyword in the A/V querying statement is a subject keyword or an instance keyword; and

obtain at least one instance having association with the instance keyword and/or at least one instance belonging to the subject keyword according to the keyword.

The obtaining module 33 is configured to:

if the keyword in the A/V querying statement is an instance keyword, obtain at least one instance having association with the instance keyword; and

accordingly, the constructing module 34 is configured to:

construct the search result knowledge graph according to the instance keyword, the at least one instance and the association between the instance keyword and the at least one instance.

Or, the obtaining module 33 is configured to:

if the keyword in the A/V querying statement is a subject keyword, obtain at least one instance belonging to the subject keyword; and

accordingly, the constructing module 34 is configured to:

construct the search result knowledge graph according to the subject keyword, the at least one instance and the association between the subject keyword and the at least one instance.

Or, the obtaining module 33 is configured to:

if the keywords in the A/V querying statement include a subject keyword and an instance keyword, obtain at least one instance having association with the instance keyword and at least one instance belonging to the subject keyword according to the keyword; and

accordingly, the constructing module 34 is configured to:

construct the search result knowledge graph according to the subject keyword, the instance keyword, the at least one instance having association with the instance keyword, the at least one instance belonging to the subject keyword, the association between the instance keyword and the at least one instance having association with the instance keyword, and the association between the subject keyword and the at least one instance belonging to the subject keyword.

The A/V searching apparatus provided in this embodiment further includes:

a displaying module 35, configured to display the search result knowledge graph after the constructing module 34 constructs the search result knowledge graph according to the keyword, the instance and the association between the keyword and the instance.

The A/V searching apparatus of this embodiment is capable of executing the A/V searching method provided in embodiments of this disclosure following similar principals, which will not be repeated herein.

This disclosure further provides an A/V searching apparatus that includes: a memory storing instructions; a processor coupled with the memory and configured to execute the instructions stored in the memory, and the processor is configured to:

receive an A/V querying statement;

determine a keyword from the A/V querying statement;

obtain at least one instance having association with the keyword; and

construct a search result knowledge graph according to the keyword, the instance and the association between the keyword and the instance, where the search result knowledge graph is for presenting a search result corresponding to the A/V querying statement.

The processor is configured to:

determine whether the keyword in the A/V querying statement is a subject keyword or an instance keyword; and

obtain at least one instance having association with the instance keyword and/or at least one instance belonging to the subject keyword according to the keyword.

Or, the processor is configured to:

if the keyword in the A/V querying statement is an instance keyword, obtain at least one instance having association with the instance keyword; and

construct the search result knowledge graph according to the instance keyword, the at least one instance and the association between the instance keyword and the at least one instance.

Or, the processor is configured to:

if the keyword in the A/V querying statement is a subject keyword, obtain at least one instance belonging to the subject keyword; and

construct the search result knowledge graph according to the subject keyword, the at least one instance and the association between the subject keyword and the at least one instance.

Or, the processor is configured to:

if the keywords in the A/V querying statement include a subject keyword and an instance keyword, obtain at least one instance having association with the instance keyword and at least one instance belonging to the subject keyword; and

construct the search result knowledge graph according to the subject keyword, the instance keyword, the at least one instance having association with the instance keyword, the at least one instance belonging to the subject keyword, the association between the instance keyword and the at least one instance having association with the instance keyword, and the association between the subject keyword and the at least one instance belonging to the subject keyword.

The processor is further configured to:

display the search result knowledge graph after constructing the search result knowledge graph according to the keyword, the instance and the association between the keyword and the instance.

The processor in the A/V searching apparatus of this embodiment may further be configured to execute any of the foregoing A/V searching methods provided in embodiments of this disclosure following similar principals, which will not be repeated herein.

When determining that the keywords in the A/V querying statement include subject keywords and instance keywords, this embodiment begins filtering the subject keywords to determine filtered subject keywords, and proceeds to determining instances having association with the instance keywords among the instances under each of the filtered subject keywords. After this, the search result knowledge graph can be constructed according to the subject keywords, the instance keywords, a first predefined number of instances having association with the instance keywords, a second predefined number of instances belonging to the filtered subject keywords, the association between the instance keywords and the first predefined number of instances, the association between the subject keywords and the second predefined number of instances, and the association between the keywords. The search result knowledge graph thus constructed presents, in the form of a diagram, the keywords in the A/V querying statement, the instances associated with the keywords, and the association between the keywords and the instances. Accordingly, the search result knowledge graph includes not only A/V search results corresponding to the A/V querying statement, but also the association between these results. Search results presented in this form are intuitive, concise, informative, and easy to use for the user, significantly enhancing the user experience. Meanwhile, since the search result knowledge graph can present the association between the keywords in the A/V querying statement, the association between the keywords and the instances, and the association between the instances, the search result knowledge graph can include not only the search results most relevant to the user's query, but also the association between the results, as well as instances having certain association with the most relevant results, allowing the user to refer to the search result knowledge graph thus displayed and determine which of the instances fully or partially match the user's querying statement. This can help the user interpret the results, preventing misunderstanding of the search results thus presented.

Yet some other embodiments of this disclosure provide a terminal, where the terminal is provided with the A/V searching apparatus in the above described embodiments.

In this embodiment, the terminal is provided with the A/V searching apparatuses described in the foregoing embodiments, where the A/V searching apparatuses have the same structures, and operates under the same principals, as those provided in the above embodiments, neither of which will be repeated herein.

In this embodiment, by determining the keyword in the received A/V querying statement, obtaining at least one instance having association with the keyword, the search result knowledge graph can be constructed according to the keyword, the instance and the association between the keyword and the instance; and the constructed search result knowledge graph presents the keywords in the A/V querying statement, the instances associated with the keywords, and the association between the keywords and the instances in the form of a diagram. Accordingly, the search result knowledge graph includes not only A/V search results corresponding to the A/V querying statement, but also the association between these results. Search results presented in this form are intuitive, concise, informative, and easy to use for the user, significantly enhancing the user experience.

Lastly, it should be noted that the foregoing embodiments are merely intended for explaining, rather than limiting, the technical solutions of the present disclosure. Although the present disclosure is explained in detail with reference to the foregoing embodiments, persons of ordinary skill in the art should understand that it remains possible to make modifications to the technical solutions described in the foregoing embodiments, or make equivalent replacements to some of the technical features therein, and these modifications or replacements do not make the essence of corresponding technical solutions depart from the spirit and scope of the technical solutions in the embodiments of the present disclosure.

What is claimed is:

1. An audio/video (A/V) searching method, comprising:
receiving an A/V querying statement;
determining a keyword from the A/V querying statement;
obtaining at least one instance having association with the keyword; and
constructing a search result knowledge graph according to the keyword, the instance and the association between the keyword and the instance, wherein the search result knowledge graph is for presenting a search result corresponding to the A/V querying statement.

2. The method according to claim 1, wherein the obtaining at least one instance having association with the keyword comprises:
determining whether the keyword in the A/V querying statement is a subject keyword or an instance keyword, wherein the subject keyword indicates a genre in the field of A/V entertainment, the instance keyword indicates an instance under a subject keyword; and
obtaining at least one instance having association with the instance keyword and/or at least one instance belonging to the subject keyword according to the keyword.

3. The method according to claim 1, wherein the obtaining at least one instance having association with the keyword comprises:
if the keyword in the A/V querying statement is an instance keyword, obtaining at least one instance having association with the instance keyword; and
the constructing a search result knowledge graph according to the keyword, the instance and the association between the keyword and the instance comprises:
constructing the search result knowledge graph according to the instance keyword, the at least one instance and the association between the instance keyword and the at least one instance.

4. The method according to claim 1, wherein the obtaining at least one instance having association with the keyword comprises:
if the keyword in the A/V querying statement is a subject keyword, obtaining at least one instance belonging to the subject keyword; and
the constructing a search result knowledge graph according to the keyword, the instance and the association between the keyword and the instance comprises:
constructing the search result knowledge graph according to the subject keyword, the at least one instance and the association between the subject keyword and the at least one instance.

5. The method according to claim 1, wherein the obtaining at least one instance having association with the keyword comprises:
if the keyword in the A/V querying statement comprises a subject keyword and an instance keyword, obtaining at least one instance having association with the instance keyword and at least one instance belonging to the subject keyword;
the constructing a search result knowledge graph according to the keyword, the instance and the association between the keyword and the instance comprises:
constructing the search result knowledge graph according to the subject keyword, the instance keyword, the at least one instance having association with the instance keyword, the at least one instance belonging to the subject keyword, the association between the instance keyword and the at least one instance having association with the instance keyword, and the association between the subject keyword and the at least one instance belonging to the subject keyword.

6. The method according to claim 1, wherein after the constructing a search result knowledge graph according to the keyword, the instance and the association between the keyword and the instance, the method further comprises:
displaying the search result knowledge graph.

7. The method according to claim 1, wherein the receiving an A/V querying statement comprises:
receiving speech querying information for A/V; and obtaining the A/V querying statement by performing speech recognition on the speech querying information.

8. An audio/video (A/V) searching apparatus, comprising: a memory storing instructions; a processor coupled with the memory and configured to execute the instructions stored in the memory, and the processor is configured to:
receive an A/V querying statement;
determine a keyword from the A/V querying statement;
obtain at least one instance having association with the keyword; and
construct a search result knowledge graph according to the keyword, the instance and the association between the keyword and the instance, wherein the search result knowledge graph is for presenting a search result corresponding to the A/V querying statement.

9. The apparatus according to claim 8, wherein the processor is configured to:
determine whether the keyword in the A/V querying statement is a subject keyword or an instance keyword, wherein the subject keyword indicates a genre in the field of A/V entertainment, the instance keyword indicates an instance under a subject keyword; and
obtain at least one instance having association with the instance keyword and/or at least one instance belonging to the subject keyword according to the keyword.

10. The apparatus according to claim 8, wherein the processor is configured to:
if the keyword in the A/V querying statement is an instance keyword, obtain at least one instance having association with the instance keyword; and
construct the search result knowledge graph according to the instance keyword, the at least one instance and the association between the instance keyword and the at least one instance.

11. The apparatus according to claim 8, wherein the processor is configured to:
if the keyword in the A/V querying statement is a subject keyword, obtain at least one instance belonging to the subject keyword; and
construct the search result knowledge graph according to the subject keyword, the at least one instance and the association between the subject keyword and the at least one instance.

12. The apparatus according to claim 8, wherein the processor is configured to:
if the keyword in the A/V querying statement comprises a subject keyword and an instance keyword, obtain at least one instance having association with the instance keyword and at least one instance belonging to the subject keyword;
construct the search result knowledge graph according to the subject keyword, the instance keyword, the at least one instance having association with the instance keyword, the at least one instance belonging to the subject keyword, the association between the instance keyword and the at least one instance having association with the instance keyword, and the association between the subject keyword and the at least one instance belonging to the subject keyword.

13. The apparatus according to claim 8, wherein the processor is further configured to:
display the search result knowledge graph after constructing the search result knowledge graph according to the keyword, the instance and the association between the keyword and the instance.

14. A terminal, wherein the terminal is provided with an audio/video (A/V) searching apparatus according to claim 8.
